(19) United States
(12) Patent Application Publication
(10) Pub. No.: US 2026/0110270 A1
(43) Pub. Date: Apr. 23, 2026

(54) MULTI-WALLED FUEL SYSTEM, METHOD OF OPERATING MULTI-WALLED FUEL SYSTEM, AND ENGINE CONTAINING MULTI-WALLED FUEL SYSTEM

(71) Applicant: Cummins Inc., Columbus, IN (US)

(72) Inventors: Simon Anthony Burge, Rugby (GB); Luke Thomas Jennings, Daventry (GB); Frank Louis Ruggiero, Covington, LA (US); Vincent Denoyelle, Long Lawford (GB); Michael Douglas Drew, Landrum, SC (US); Bryce Tiller, Columbus, IN (US); Anthony A. Lewis, Columbus, IN (US); Matthew W. Isaacs, Summerville, SC (US); Jonathan W. Georgas, Columbus, IN (US)

(73) Assignee: Cummins Inc., Columbus, IN (US)

(21) Appl. No.: 19/364,822

(22) Filed: Oct. 21, 2025

(30) Foreign Application Priority Data
Oct. 22, 2024 (GB) 2415525.1

(51) Int. Cl. F02D 19/06

(52) U.S. Cl. CPC F02D 19/0684; F02D 19/0678

(57) ABSTRACT

A fuel evacuation system includes an outer fluid pathway and an inner fluid pathway arranged therein. The system also includes a controller to control flows of gas and liquid fuel from respective first and second sources, and a sealing member coupled to the inner and outer fluid pathways, where the sealing member is operable between a first and at least one second position. In the first position, the sealing member enables the outer fluid pathway to be fluidly independent from the inner fluid pathway. In the at least one second position, the sealing member couples the outer fluid pathway to the inner fluid pathway. In a first mode, the controller causes liquid fuel from the inner fluid pathway to flow to the outer fluid pathway. In a second mode, the controller is configured to cause gas from the outer fluid pathway to flow to the inner fluid pathway.

### CROSS-REFERENCE TO RELATED APPLICATIONS

This application claims the benefit of and priority to United Kingdom Application No. 2415525.1, filed on Oct. 22, 2024, the entire disclosure of which is hereby incorporated by reference.

### TECHNICAL FIELD

The present disclosure relates generally to the field of engines, and fuel systems for engines.

### BACKGROUND

A fuel system for an engine can include a plurality of fueling or supply lines, which are structured to provide an amount of fuel to one or more cylinders within the engine. The fueling lines in the fuel system can be double walled to isolate fuel within the fueling line. Space between the outer wall and the inner wall can be used as a reservoir or collection location to receive leaked fuel from the inner wall.

### SUMMARY

One aspect of the present disclosure relates to an evacuation system for an engine. The system includes an outer fluid pathway in fluid communication with a gas from a first source and an inner fluid pathway arranged within the outer fluid pathway, the inner fluid pathway in fluid communication with a liquid fuel from a second source. The system further icnludes at least one controller configured to control flow of the gas from the first source and flow of the liquid fuel from the second source, and a sealing member coupled to a terminal end of each of the outer fluid pathway and the inner fluid pathway, where the sealing member is selectively operable between a first position and at least one second position. In the first position, the sealing member enables the outer fluid pathway to be fluidly independent from the inner fluid pathway. In the second position, the sealing member enables the outer fluid pathway to be fluidly coupled to the inner fluid pathway such that the fuel evacuation system can be operable in one of a first mode or a second mode. In the first mode, the at least one controller is configured to cause liquid fuel from the second source to flow from the inner fluid pathway to the outer fluid pathway such that gas within the outer fluid pathway flows toward the first source. In the second mode, the at least one controller is configured to cause gas from the first source to flow from the outer fluid pathway to the inner fluid pathway such that liquid fuel within the inner fluid pathway flows toward the second source.

In various embodiments, the system further includes a fuel line fluidly coupled to each of the first source and the second source, where the fuel line includes a first wall and a second wall, and where the second fluid pathway is formed by a space defined within the second wall and the first fluid pathway is formed by a space defined between the second wall and the first wall. In some embodiments, the fuel line is a fuel line configured to provide the liquid fuel to a plurality of cylinders within the engine. In other embodiments, the gas is an inert gas. In yet other embodiments, the gas is a non-inert gas. In various embodiments the inner fluid pathway is concentrically arranged within the outer fluid pathway. In some embodiments, a pressure of the gas from the first source is greater than or equal to atmospheric pressure. In other embodiments, the pressure of the gas from the first source is less than atmospheric pressure. In yet other embodiments, the sealing member includes a collar portion, and a plug concentrically arranged within the collar portion, where the collar portion is configured to couple to an exterior of the outer fluid pathway, and where the plug is configured to be received within a portion of each of the outer fluid pathway and the inner fluid pathway. In various embodiments, the plug is spaced from a terminal end of each of the outer fluid pathway and the inner fluid pathway when the sealing member is in the second position, and the plug is received by the terminal end of each of the outer fluid pathway and the inner fluid pathway when the sealing member is in the first position.

Another aspect of the present disclosure relates to a fuel supply component. The fuel supply component includes a sealing member configured to threadably couple to a terminal end of a conduit, a collar configured to couple to the conduit, and a plug extending through the collar, where the plug includes a first portion extending from a first side of the collar and a second portion extending into a hollow portion of the collar; where an inner portion of the collar is threaded.

In various embodiments, the conduit includes an inner wall and an outer wall, where an inner fluid pathway is defined by the inner wall, and an outer fluid pathway is defined by a space between the inner wall and the outer wall, the outer wall surrounding the inner wall, where the first fluid pathway is in fluid communication with a first source and the second fluid pathway is in fluid communication with a second source, where the sealing member is moveable between a first position and at least one second position, and where a first stream from the first source flows from the first fluid pathway to the second fluid pathway or a second stream from the second source flows from the second fluid pathway to the first fluid pathway when the sealing member is in the at least one second position, the first fluid pathway being fluidly isolated from the second fluid pathway when the sealing member is in the first position. In some embodiments, a diameter of the second portion of the plug is stepped. In other embodiments, the collar is configured to couple to the outer wall, where the valve portion is configured to seal each of the inner fluid pathway and the outer fluid pathway when the sealing member is in the first position, and configured to unseal each of the inner fluid pathway and the outer fluid pathway when the sealing member is in the at least one second position. In yet other embodiments, the second portion is structured as a valve. In various embodiments, the fuel supply component further includes a second conduit fluidly coupled to the outer fluid pathway at a first end and a second end, the outer conduit configured to receive a third stream from a third source. In various embodiments, the first stream is a liquid fuel and the third stream is a first gas. In some embodiments, the first stream is a liquid and the second stream is a second gas.

Yet another aspect of the present disclosure relates to a method of evacuating a fuel within an engine by a fuel evacuation system, the fuel evacuation system having an outer fluid pathway in fluid communication with a gas from a first source, an inner fluid pathway arranged within the outer fluid pathway and being in fluid communication with a liquid fuel from a second source, and a sealing member coupled to a terminal end of each of the outer fluid pathway and the inner fluid pathway. The method includes repositioning the sealing member within the fuel evacuation system from a first position to at least one second position such that the outer fluid pathway is in fluid communication with the inner fluid pathway, and while the sealing member is in the at least one second position, controlling, by a controller operably coupled to the fuel evacuation system, the fuel evacuation system in one of a first purging mode or a second purging mode.

In various implementations, controlling the fuel evacuation system in the first purging mode includes causing gas from the first source to flow from the outer fluid pathway to the inner fluid pathway to purge liquid fuel within the inner fluid pathway such that the liquid fuel within the inner fluid pathway flows to the second source. In some implementations, controlling the fuel evacuation system in the second purging mode includes causing liquid fuel from the second source to flow from the inner fluid pathway to the outer fluid pathway to purge gas within the outer fluid pathway such that gas within the outer fluid pathway flows to the first source. In other implementations, repositioning the sealing member from the first position to the at least one second position includes unthreading the sealing member from the terminal end of each of the outer fluid pathway and the inner fluid pathway. In yet other implementations, the method also includes controlling, by the controller, a pressure of the gas from the first source. In various implementations, repositioning the sealing member from the first position to the at least one second position includes spacing the sealing member from a terminal end from each of the outer fluid pathway and the inner fluid pathway. In some implementations, spacing the sealing member from the terminal end of each of the outer fluid pathway and the inner fluid pathway includes moving a collar portion of the sealing member away from an outer wall of the outer fluid pathway such that a plug within the collar portion unseals the terminal end of each of the outer fluid pathway and the inner fluid pathway.

This summary is illustrative only and should not be regarded as limiting.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a fueling system within an engine, according to at least one embodiment.

FIG. 2 is a perspective view of a fuel evacuation system within the fueling system of FIG. 1, according to at least one embodiment.

FIG. 3 is a side cross-sectional view of a fuel evacuation system within the fueling system of FIG. 2, according to at least one embodiment.

FIG. 4 is an end cross-sectional view of the fuel evacuation system of FIG. 2, taken along line A-A of FIG. 2, according to at least one embodiment.

FIG. 5 is a side cross-sectional view of the fuel evacuation system of FIG. 2, taken along line B-B of FIG. 2, according to at least one embodiment.

FIG. 6 is an end cross-sectional view of a fuel line within the fuel evacuation system of FIG. 2, taken along line C-C of FIG. 5, according to at least one embodiment.

FIG. 7 is a side cross-sectional view of the fuel evacuation system of FIG. 2 near an end of the fuel line, illustrating a sealing member in a first position, according to at least one embodiment.

FIG. 8 is a side cross-sectional view of the fuel evacuation system of FIG. 2 near an end of the fuel line, illustrating the sealing member in a second position, according to at least one embodiment.

FIG. 9 is a perspective view of the sealing member of FIG. 6, according to at least one embodiment.

FIG. 10 is an alternate perspective view of the sealing member of FIG. 7, according to at least one embodiment.

FIG. 11 is a side cross-sectional view of the sealing member of FIG. 7, taken along line D-D of FIG. 10, according to at least one embodiment.

FIG. 12 is a schematic representation of the fuel evacuation system of FIG. 2 in a closed mode, according to at least one embodiment.

FIG. 13 is a schematic representation of the fuel evacuation system of FIG. 2 in a first purge mode, according to at least one embodiment.

FIG. 14 is a schematic representation of the fuel evacuation system of FIG. 2 in a vent mode, according to at least one embodiment.

FIG. 15 is a schematic representation of the fuel evacuation system of FIG. 2 in a second vent mode, according to at least one embodiment.

FIG. 16 is a side view of a fuel evacuation system within the fueling system of FIG. 1, according to at least one embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments can be utilized, and other changes can be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are contemplated and made part of this disclosure.

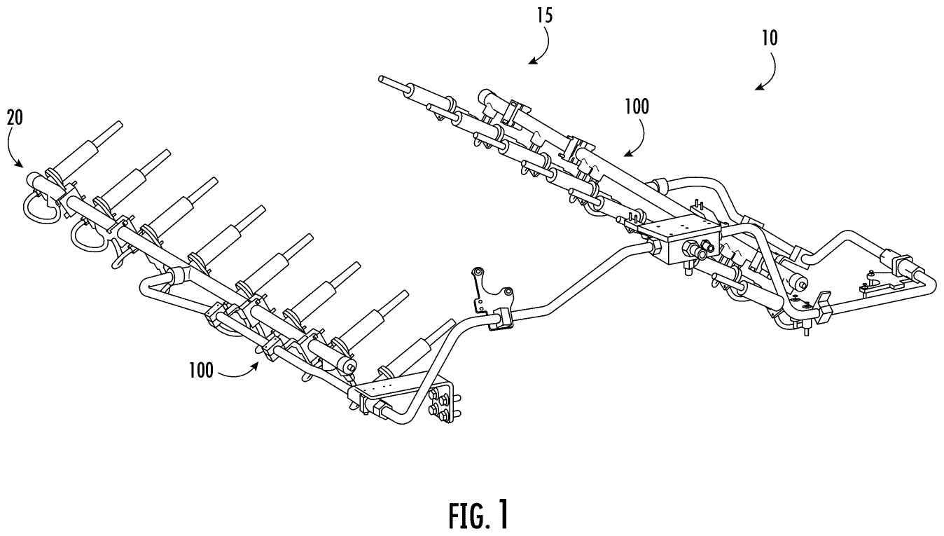

Referring to FIG. 1, a fueling system 10 for an engine is shown, according to at least one embodiment. The fueling system 10 can include a plurality of fueling lines, each structured to provide a flow of fuel to at least one cylinder in at least one engine bank. In some embodiments, the fueling system 10 can include a first bank 15 corresponding to a first set of cylinders and a second bank 20 corresponding to a second set of cylinders. In various embodiments, each of the banks 15 and 20 are structured to include a fuel evacuation system 100 configured to facilitate provision and evacuation of fuel within the corresponding engine banks. It should be noted that although FIG. 1 shows two banks, in various embodiments, the fueling system 10 can include any number of banks.

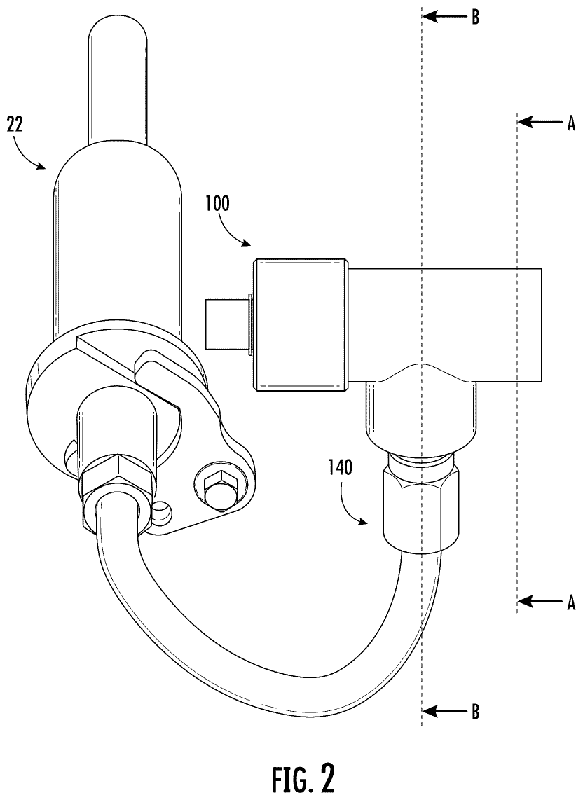

FIG. 2 shows a perspective view of a fuel evacuation system 100 within the fueling system 10, according to at least one embodiment. FIG. 3 shows a cross-sectional view of a fuel evacuation system 100, according to at least one embodiment. As shown, the fuel evacuation system 100 can include at least one fuel line or fuel line segment 105 (“conduit”), which is structured to provide a fuel to at least one cylinder within at least one engine bank in an engine. In various embodiments, the fuel is a liquid. In various embodiments, the fuel is a gas. In some embodiments, the fuel includes at least one of ethanol or methanol. The fuel can be diesel or natural gas, an e-fuel or liquid biofuel. The fuel can be any one of a high cetane number fuel, such as diesel, gas-to-liquid (GTL) diesel, heavy fuel oil (HFO), low sulfur fuel oil (LFSO), hydrotreated vegetable oil (HVO), marine gas oil (MGO), renewable diesel, biodiesel, paraffinic diesel, dimethyl ether (DME), F-76 fuel, F-34 fuel, jet A fuel, JP-4 fuel, JP-8 fuel, or oxymethylene ether (OME), or a low cetane number fuel (e.g., a high octane number fuel, a high methane number fuel). The low cetane number fuel can be natural gas, hydrogen, ethane, propane, butane, syngas, ammonia, methanol, ethanol, or gasoline. The fuel can optionally be a blend of fuels. It should be appreciated that the foregoing are merely examples of fuels, and other types of fuels are not precluded.

As shown, the fuel line segment 105 can be fluidly coupled to a second fuel line segment 140 at one or more fluid junctions 110. In various embodiments, the fluid junction 110 can include one or more valves configured to control a flow of fuel through at least one of the fuel line segment 105 or the fuel segment 140. As shown, the fuel line segment 105 can be coupled to a sealing member 130 at an end 115 of the fuel line segment 105. In various embodiments, the sealing member 130 is structured to at least partially overlap the end 115. The sealing member 130 can include at least one seal or plug 135, which is structured to fluidly seal the end 115 of the fuel line segment 105.

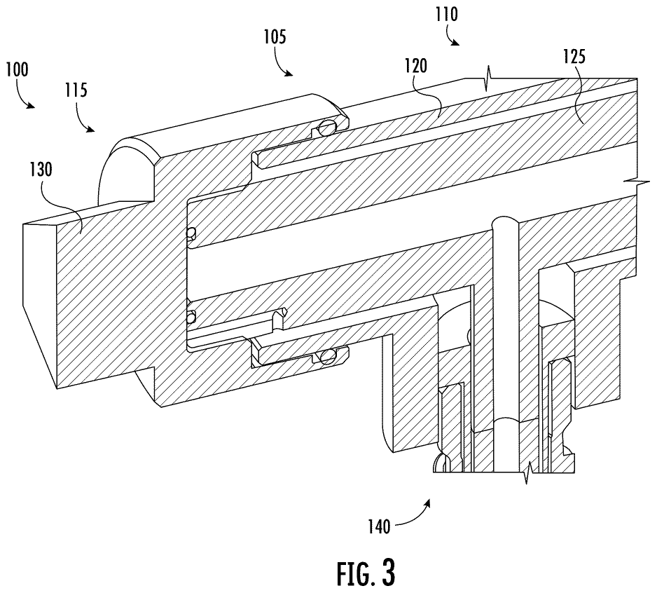

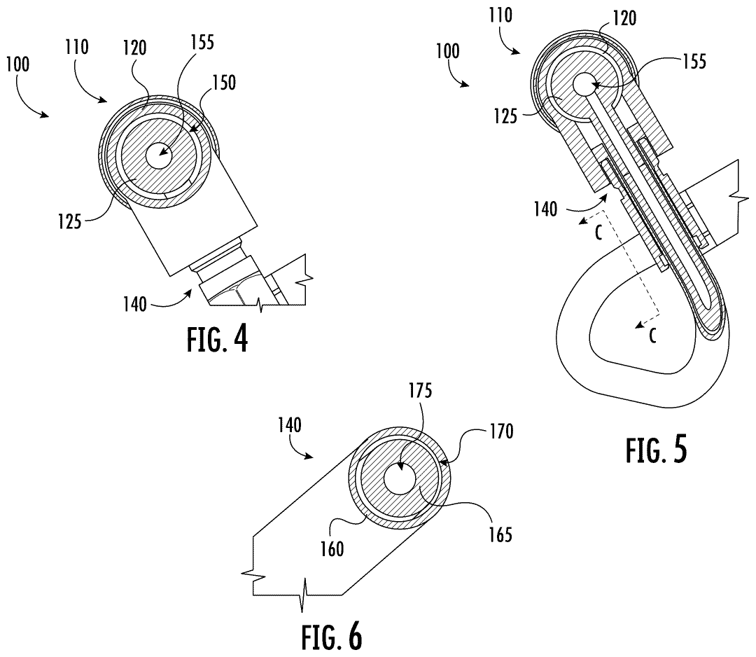

The fuel line segment 105 can be structured as a double walled fuel line. As shown, the fuel line segment 105 can include an outer wall 120 (“outer rail”) and an inner wall 125 (“inner rail”). As shown in FIGS. 4-5, the outer wall 120 defines a first fluid pathway 150 (“outer fluid pathway”), which can be fluidly connected to at least a first source and configured to receive a first stream from the first source. In various embodiments, the first source is a gas source and the first stream is a gas. For example, the first source can be a source of nitrogen gas. In other embodiments, the first source can be a source of air. In yet other embodiments, the first source can be a source of an inert gas or a non-inert gas. In some embodiments, the first source can be a source of liquid. In various embodiments, a pressure of gas from the first source is greater than atmospheric pressure. In various embodiments, the pressure of gas from the first source is equal to atmospheric pressure. In other embodiments, the pressure of gas from the first source is less than atmospheric pressure (i.e., a vacuum). The inner wall 125 defines a second fluid pathway 155 (“inner fluid pathway”), which can be fluidly connected to at least a second source and configured to receive a second stream. In various embodiments, the second source is a fuel source. For example, the second source can be a liquid fuel source and the second stream can be a liquid fuel. In various embodiments, the liquid fuel includes at least one of methanol or ethanol.

As shown, the inner fluid pathway 155 is disposed within the outer fluid pathway 150. In some embodiments, the inner fluid pathway 155 is disposed concentrically within the outer fluid pathway 150. During use of the fuel evacuation system 100, the outer wall 120 and the outer fluid pathway 150 is structured to function as a collection space or reservoir to receive leakages from within the inner fluid pathway 155. Accordingly, in some embodiments, the outer fluid pathway 150 can be configured as a neutralizing layer to neutralize, render inert, or otherwise decrease volatility of leakages from within the inner fluid pathway 155.

As shown in FIG. 6, the fuel line segment 140 can be structured similarly to the fuel line segment 105. In various embodiments, the fuel line segment 140 can include an outer wall 160 and an inner wall 165, where the outer wall 160 surrounds the inner wall 165. As shown, the outer wall 160 forms a first fluid pathway 170 (“outer fluid pathway”) and the inner wall 165 forms a second fluid pathway 175 (“inner fluid pathway”) disposed within the outer fluid pathway 170. The outer fluid pathway 170 can be fluidly connected to at least a third source and configured to receive a third stream from the third source. In various embodiments, the third source is a gas source and the third stream is a gas. For example, the third source can be a source of nitrogen gas. In other embodiments, the third source can be a source of air. In yet other embodiments, the third source can be a source of an inert or a non-inert gas. In some embodiments, the third source can be a source of liquid. In various embodiments, the third source is the same as the first source. For example, in some embodiments, a same source of gas (e.g., nitrogen, compressed air, etc.) provides a stream to each of the outer fluid pathway 170 and the outer fluid pathway 150. In other embodiments, the first source and the third source can be different. For example, in some embodiments, the first source is a source of an inert gas and the third source is a source of compressed air. In other embodiments, the first source is a source of nitrogen and the third source is a source of compressed air.

In various embodiments, the inner fluid pathway 175 can be fluidly connected to at least a fourth source and configured to receive a fourth stream from the fourth source. In various embodiments, the fourth source is a fuel source. For example, the fourth source can be a liquid fuel source and the fourth stream can be a liquid fuel. In various embodiments, the fourth source is the same as the second source. For example, in some embodiments, a same source of fuel (e.g., liquid methanol) provides a stream to each of the inner fluid pathway 175 and the inner fluid pathway 155.

In various embodiments, each of the first source, second source, third source, or fourth source is coupled to at least one controller, which is configured to control a flow from each respective source. For example, the at least one controller can include at least one controllable valve. In various embodiments, the at least one controllable valve is structured for manual control. In other embodiments, the at least one controllable valve is structured to receive at least one control input from a controller in communication with the fuel evacuation system 100, where the at least one control input causes the at least one controllable valve to undergo a change in operational state (e.g., from open to closed, or closed to open). In various embodiments, at least one of the fuel line segment 105 or the fuel line segment 140 is a primary fuel line configured to provide liquid fuel to a plurality of cylinders within an engine.

In various embodiments, the outer fluid pathway 150 and the inner fluid pathway 155 are fluidly independent such that the first stream through the outer fluid pathway 150 is isolated from the second stream through the second fluid pathway 155. In other embodiments, the outer fluid pathway 150 and the inner fluid pathway 155 can be selectively connected. When the outer fluid pathway 150 and the inner fluid pathway 155 are fluidly connected, the fuel evacuation system 100 can be operated to purge, vent, de-aerate, or otherwise modify flow of fuel within the fuel line segment 105.

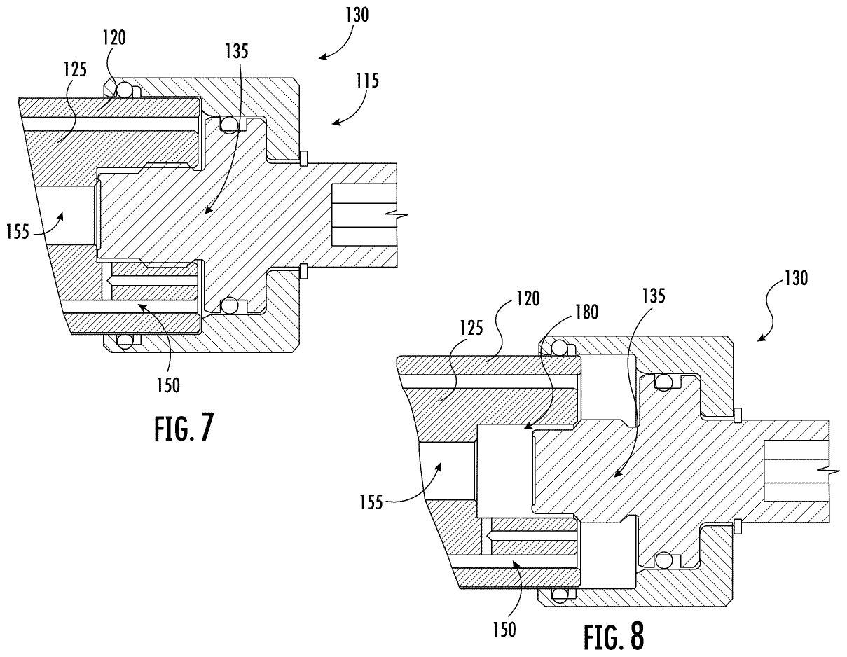

As described above, the fuel evacuation system 100 includes at least one sealing member 130, which is structured to couple to the end 115 of the fuel line segment 105. In various embodiments, the sealing member 130 can be selectively transitioned from a first position to at least one second position relative to the end 115 such that the sealing member 130 becomes spaced from the end 115. Accordingly, when the sealing member 130 is in the first position, such as shown in FIG. 7, the outer fluid pathway 150 and the inner fluid pathway 155 are fluidly independent. When the sealing member 130 is in the second position, such as shown in FIG. 8, the outer fluid pathway 150 and the inner fluid pathway 155 are fluidly connected. Thus, when the sealing member 130 is in the first position, the plug 135 (i.e., a valve member), which is disposed within the sealing member 130, is in closed position such that it seals the ends of both the outer fluid pathway 150 and the inner fluid pathway 155. When the sealing member 130 is in the second position, the sealing member 130 can remain coupled to the end 115 while the plug 135 is spaced from the end 115 such that it unseals the outer fluid pathway 150 and the inner fluid pathway 155 to fluidly connect. In various embodiments, the second position includes a plurality of positions such that the sealing member 130 can be selectively adjusted to control an amount and/or rate of flow of between the outer fluid pathway 150 and the inner fluid pathway 155. In various embodiments, the plug 135 is a valve. In various embodiments, the plug 135 is a ball valve.

As shown in FIGS. 7-8, the sealing member 130 can be configured such that it at least partially extends over an exterior of the outer wall 120 overlap with the end 115. The plug 135 can be configured to be received within a recess 180 defined within at least one of the outer wall 120 and the inner wall 125. In various embodiments, the outer wall 120 has a thickness that is less than the inner wall 125. In various embodiments, a width of the outer fluid pathway 150 is less than a width of the inner fluid pathway 155, where the width of the outer fluid pathway 150 is defined as a radial distance between the outer wall 120 and the inner wall 125.

In various embodiments, the fuel evacuation system 100 includes the outer fluid pathway 150 in fluid communication with a gas from a first source, the inner fluid pathway 155 arranged within the outer fluid pathway 150, where the inner fluid pathway 155 is in fluid communication with a liquid fuel from a second source, at least one controller configured to control flow of the gas from the first source and flow of the liquid fuel from the second source, and the sealing member 130 coupled to the terminal end 115 of each of the outer fluid pathway 150 and the inner fluid pathway 155. In various embodiments, the sealing member 130 is selectively operable between a first position and at least one second position, where, in the first position, the sealing member 130 enables the outer fluid pathway 150 to be fluidly independent from the inner fluid pathway 155, and where, in the second position, the sealing member 130 enables the outer fluid pathway 150 to be fluidly coupled to the inner fluid pathway 155 such that the fuel evacuation system 100 can be operable in one of a plurality of modes. In various embodiments the fuel evacuation system 100 can be operable in one of a first mode or a second mode. In various embodiments, when in the first mode, the at least one controller is configured to cause gas from the first source to flow from the outer fluid pathway 150 to the inner fluid pathway 155 such that liquid fuel within the inner fluid pathway 155 flows toward the second source. In various embodiments, when in the second mode, the at least one controller is configured to cause liquid fuel from the second source to flow from the inner fluid pathway 155 to the outer fluid pathway 150 such that gas within the outer fluid pathway 150 flows toward the first source, and when in the second mode.

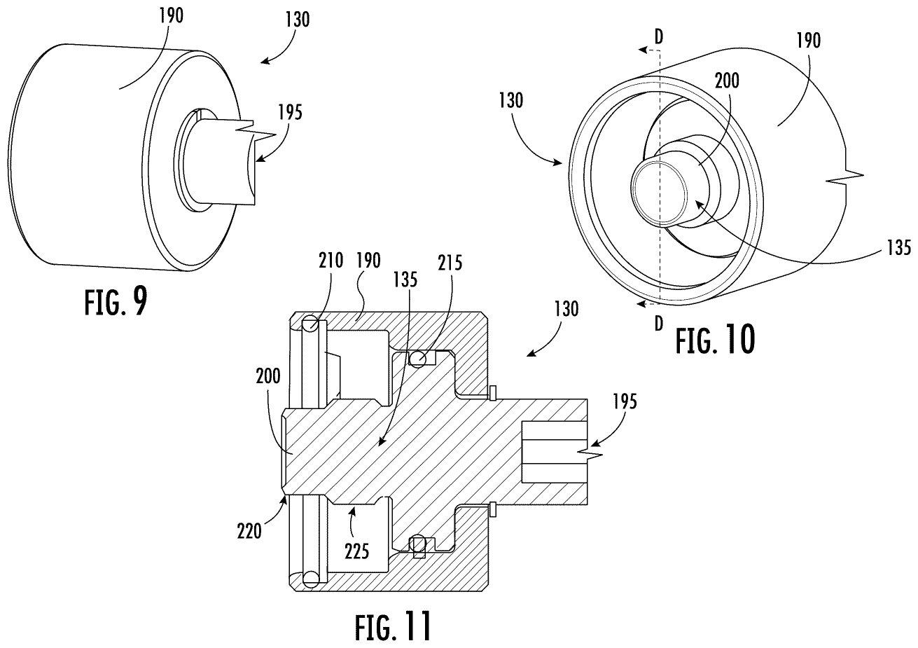

FIGS. 9-11 show alternate views of the sealing member 130 in accordance with various embodiments. As shown in FIGS. 9-10, the sealing member 130 can include a collar portion 190 formed as a hollow cylindrical body. The collar portion 190 can be structured to have an inner diameter corresponding to an outer diameter of the outer wall 120 such that the collar portion 190 can be coupled to the end 115 in an overlapping arrangement. In various embodiments, an inner surface of the collar portion 190 can include a plurality of threads, which are structured to engage with corresponding threads on an exterior portion of the outer wall 120. Accordingly, the sealing member 130 can be threadably coupled to the end 115 of the fuel line segment 105. In other embodiments, the sealing member 130 can be configured to couple to the end 115 via one or more fasteners, clips, or any other suitable methods known in the art.

As shown in FIGS. 9-11, the sealing member 130 can be structured such that the plug 135 is concentrically arranged within and extends through the collar portion 190. Accordingly, as shown a portion 195 of the plug 135 can extend axially outward from the collar portion 190 in a direction away from the fuel line segment 105. In various embodiments, the portion 195 can be structured as a knob, handle, or other implement to facilitate manipulating the sealing member 130 relative to the end 115. The plug 135 can also include a second portion 200, which is disposed within a hollow portion of the collar portion 190 and extend inward toward the end 115 such that it can be received therein. In various embodiments, the second portion 200 can have a generally cylindrical shape. In some embodiments, the second portion 200 can have a stepped configuration such that the second portion 200 has at least one region 220 with a diameter that is less than that in a second region 225 to facilitate sealing of the outer fluid pathway 150 and the inner fluid pathway 155.

As shown in FIG. 11, the plug 135 can be structured to extend through the collar portion 190. In other embodiments, the plug 135 can be contained within the collar portion 190 and extending only in the direction of the end 115. In various embodiments, the plug 135 can be formed as a unitary member. In other embodiments, the plug 135 can be formed of separate components, which can be coupled together to facilitate selective sealing of the fluid pathways 150 and 155.

In various embodiments, the sealing member 130 can include one or more secondary seals to facilitate fluidly sealing the outer fluid pathway 150 and the inner fluid pathway 155. For example, as shown in FIG. 11, the sealing member 130 can include at least one secondary seal 210 disposed within or coupled to an inner wall portion of the collar portion 190 such that the at least one secondary seal 210 engages with an outer portion of the outer wall 120. In other embodiments, the sealing member 130 can include at least one secondary seal 215 disposed between the plug 135 and the collar portion 190. In some embodiments, the secondary seal 215 is structured to facilitate or enhance a fluid seal between the collar portion 190 and the plug 135. In various embodiments, the secondary seals 210 and 215 can be gaskets, o-rings, or any other suitable seal known in the art.

In various embodiments, the fuel evacuation system 100 can include one or more fuel supply components configured to control flow of gas and/or fuel through the fuel system 10. In some embodiments, a fuel supply component includes a conduit (e.g., the fuel line segment 105) having the outer wall 120 and the inner wall 125, and the sealing member 130 configured to threadably couple to the terminal end 115 of the conduit. In such embodiments, an inner fluid pathway 155 is defined by an inner wall 125, and an outer fluid pathway 150 is defined by a space between the inner wall 125 and the outer wall 120, where the outer wall 120 surrounds the inner wall 125. In various embodiments, the inner fluid pathway 155 is in fluid communication with a first source and the outer fluid pathway 150 is in fluid communication with a second source, where the sealing member 130 is moveable between a first position and the at least one second position, and where a first stream from the first source flows from the inner fluid pathway 155 to the outer fluid pathway 150 or a second stream from the second source flows from the outer fluid pathway 150 to the inner fluid pathway 155 when the sealing member 130 is in the at least one second position, and where the inner fluid pathway 155 is fluidly isolated from the outer fluid pathway 150 when the sealing member 130 is in the first position.

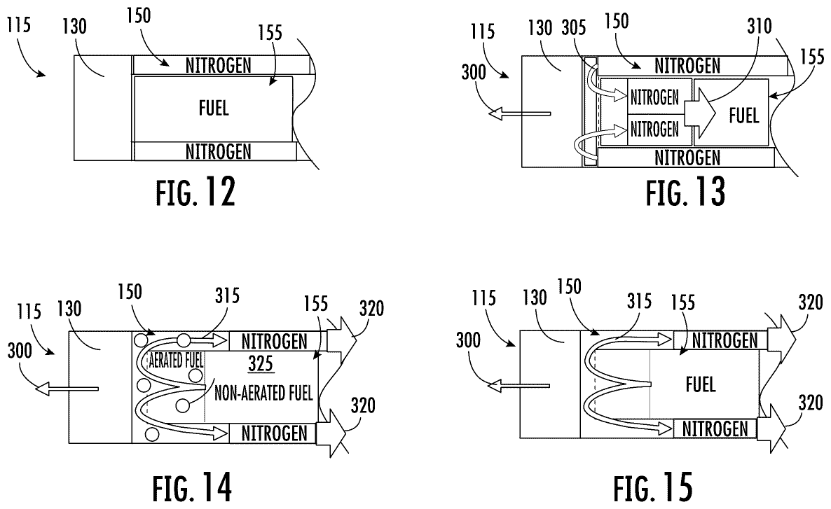

During operation of the fuel evacuation system 100, the sealing member 130 can be selectively displaced relative to the end 115 such that the fuel evacuation system 100 can be operated among a plurality of modes. As shown in FIG. 12, when the sealing member 130 is in a first position (i.e., a closed position) such that it is coupled and disposed adjacent to the end 115, the outer fluid pathway 150 and the inner fluid pathway 155 are respectively sealed and fluidly independent. As shown in FIGS. 13-15, when the sealing member 130 is displaced in a direction 300 such that it becomes spaced from the end 115 (i.e., transitioned from the first position to at least one second position), the fuel evacuation system 100 can be operated in various modes.

In a first mode, as shown in FIG. 13, the sealing member 130 can be displaced in the direction 300 and a flow of the first stream from the first source can flow from the outer fluid pathway 150 in a direction 305 into the inner fluid pathway 155. Flow from the outer fluid pathway 150 can then force a flow within the inner fluid pathway 155 in a direction 310 toward the second source. Accordingly, in embodiments where the first stream within the fluid pathway 150 is a gas, when the fuel evacuation system 100 is in the first mode, the inner fluid pathway 155 can be purged of fuel, as shown in FIG. 13. For example, when in the first mode, the sealing member 130 can be spaced from the end 115 and a flow from the outer fluid pathway 150 (e.g., a flow of nitrogen) can be controlled from the first source to force liquid fuel within the inner fluid pathway 155 to flow toward the second source to evacuate the fuel from within the fueling system 10.

In a second mode, as shown in FIG. 14, the sealing member 130 can be displaced in the direction 300 and a flow of the second stream from the second source can flow from the inner fluid pathway 155 in a direction 315 into the outer fluid pathway 150. Flow from the inner fluid pathway 155 can then force a flow within the outer fluid pathway 150 in a direction 320 toward the first source. Accordingly, in embodiments where the first stream within the fluid pathway 150 is a gas, when the fuel evacuation system 100 is in the second mode, the inner fluid pathway 155 can de-aerate liquid fuel by forcing aerated fuel 325 from the inner fluid pathway 155, as shown in FIG. 14.

In a third mode, as shown in FIG. 15, the sealing member 130 can be displaced in the direction 300 and a flow of the second stream from the second source can flow from the inner fluid pathway 155 in a direction 315 into the outer fluid pathway 150. Flow from the inner fluid pathway 155 can then force a flow within the outer fluid pathway 150 in a direction 320 toward the first source. Accordingly, in embodiments where the first stream within the fluid pathway 150 is a gas, when the fuel evacuation system 100 is in the third mode, the inner fluid pathway 155 can evacuate/purge the gas from the outer fluid pathway 150 by forcing a flow of liquid fuel from the inner fluid pathway 155 into the outer fluid pathway 150, as shown in FIG. 15. In such embodiments, operation of the fuel evacuation system 100 in the third mode can be carried out during a “stop” state of the fueling system 10, in which fuel is not being provided to the engine, where the third mode can facilitate depressurization of the fuel lines.

In various embodiments, displacement of the sealing member 130 can be carried out manually or automatically. In various embodiments, displacing of the sealing member 130 to transition from a first position to the at least one second position can include threading and unthreading the sealing member 130 from the end 115. In various embodiments, the fuel evacuation system 100 can include at least one controller, where the at least one controller is configured to receive one or more inputs from a user and operate the fuel evacuation system 100 in accordance with the one or more inputs. In some embodiments, the at least one controller can operate the fuel evacuation system 100 in one or more of the first mode, second mode, or third mode responsive to an input received following displacement of the sealing member. In other embodiments, the at least one controller is configured to receive an input corresponding to at least one of the first mode, second mode, or third mode and, in response, displace the sealing member 130 and control flow through the outer fluid pathway 150 and/or inner fluid pathway 155 in accordance with the corresponding mode.

Accordingly, in various implementations, a user and/or the at least one controller can carry out a method of evacuating a fuel within an engine by the fuel evacuation system 100. The fuel evacuation system 100 including the outer fluid pathway 150 in fluid communication with a gas from a first source, an inner fluid pathway 155 arranged within the outer fluid pathway 150 and being in fluid communication with a liquid fuel from a second source, and a sealing member 130 coupled to a terminal end 115 of each of the outer fluid pathway 150 and the inner fluid pathway 155. In various implementations, the method includes repositioning the sealing member 130 within the fuel evacuation system 100 from a first position to an at least one second position such that the outer fluid pathway 150 is in fluid communication with the inner fluid pathway 155, and, while the sealing member 130 is in the at least one second position, controlling, by a controller operably coupled to the fuel evacuation system 100, the fuel evacuation system 100 is in one of a first purging mode or a second purging mode.

As described above, controlling the fuel evacuation system in the first purging mode can include causing gas from the first source to flow from the outer fluid pathway 150 to the inner fluid pathway 155 to purge liquid fuel within the inner fluid pathway 155 such that the liquid fuel within the inner fluid pathway 155 flows to the second source. Similarly, in accordance with the method, controlling the fuel evacuation system 100 in the second purging mode can include causing liquid fuel from the second source to flow from the inner fluid pathway 155 to the outer fluid pathway 150 to purge gas within the outer fluid pathway 150 such that gas within the outer fluid pathway 150 flows to the first source. In various implementations, repositioning the sealing member 130 from the first position to the at least one second position includes moving the sealing member 130 from the terminal end 115 of each of the outer fluid pathway 150 and the inner fluid pathway 155. In various implementations, moving the sealing member 130 from the terminal end 115 of each of the outer fluid pathway 150 and the inner fluid pathway 155 can include unthreading at least a portion of the sealing member 130. In various implementations, the method can include controlling, such as by the at least one controller, a pressure of the gas from the first source. In various implementations, repositioning the sealing member 130 includes spacing the sealing member 130 from the end 115. For example, in various implementations, spacing the sealing member 130 from the terminal end 115 of each of the outer fluid pathway 150 and the inner fluid pathway 155 includes sliding and/or unthreading at least one of the plug 135 or the collar portion 190 of the sealing member 130 from the outer wall of the outer fluid pathway 150 such that the plug 135 within the collar portion 190 unseals the terminal end 115 of each of the outer fluid pathway 150 and the inner fluid pathway 155.

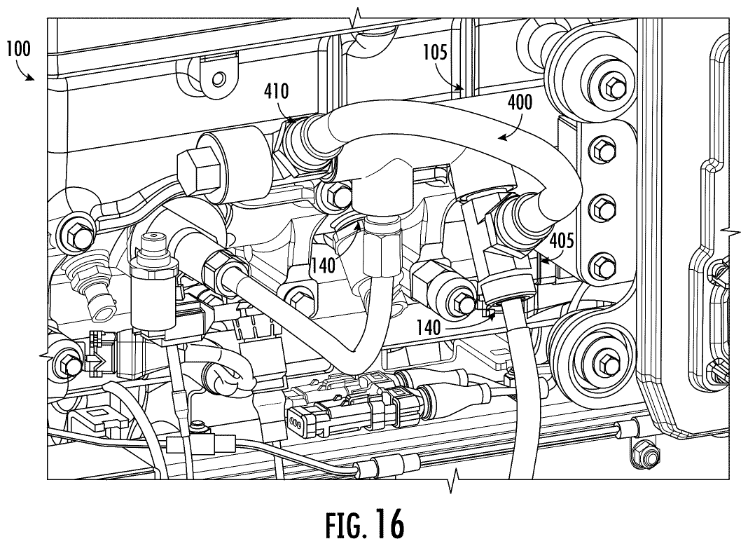

In various embodiments, the fuel evacuation system 100 can include a third fluid pathway 400, as shown in FIG. 16. The third fluid pathway 400 can be fluidly coupled to the fuel line segment 105 between a joint 405 (e.g., a tee or T-piece) and a second controllable valve 410. The third fluid pathway 400 can be structured to receive a stream of a gas from at least one source (e.g., the first source, third source). Accordingly, in some embodiments, the at least one controller can be configured to change an operational state of the controllable valve 410 such that the stream of gas from the at least one source flows into the fuel line segment 105 to purge the fuel therein.

Notwithstanding the embodiments described above in reference to FIGS. 1-16, various modifications and inclusions to those embodiments are contemplated and considered within the scope of the present disclosure.

The present technology may also include, but is not limited to, the features and combinations of features recited in the following lettered paragraphs, it being understood that the following paragraphs should not be interpreted as limiting the scope of the claims as appended hereto or mandating that all such features must necessarily be included in such claims:

A. A fuel evacuation system for an engine, the system comprising:
an outer fluid pathway in fluid communication with a gas from a first source;
an inner fluid pathway arranged within the outer fluid pathway, the inner fluid pathway in fluid communication with a liquid fuel from a second source;
at least one controller configured to control flow of the gas from the first source and flow of the liquid fuel from the second source; and
a sealing member coupled to a terminal end of each of the outer fluid pathway and the inner fluid pathway;
wherein the sealing member is selectively operable between a first position and at least one second position;
wherein, in the first position, the sealing member enables the outer fluid pathway to be fluidly independent from the inner fluid pathway; and
wherein, in the second position, the sealing member enables the outer fluid pathway to be fluidly coupled to the inner fluid pathway such that the fuel evacuation system can be operable in one of a first mode or a second mode;
   wherein in the first mode, the at least one controller is configured to cause liquid fuel from the second source to flow from the inner fluid pathway to the outer fluid pathway such that gas within the outer fluid pathway flows toward the first source; and
   wherein in the second mode, the at least one controller is configured to cause gas from the first source to flow from the outer fluid pathway to the inner fluid pathway such that liquid fuel within the inner fluid pathway flows toward the second source.

B. The fuel evacuation system of paragraph A, further comprising a fuel line fluidly coupled to each of the first source and the second source, the fuel line comprising a first wall and a second wall, the second fluid pathway being formed by a space defined within the second wall and the first fluid pathway being formed by a space defined between the second wall and the first wall.

C. The fuel evacuation system of one of paragraphs A or B wherein the fuel line is a fuel line configured to provide the liquid fuel to a plurality of cylinders within the engine.

D. The fuel evacuation system of any one of the preceding paragraphs, wherein the gas is an inert gas.

E. The fuel evacuation system of any one of paragraphs A to C, wherein the gas a non-inert gas.

F. The fuel evacuation system of any one of the preceding paragraphs, wherein the inner fluid pathway is concentrically arranged within the outer fluid pathway.

G. The fuel evacuation system of any one of the preceding paragraphs, wherein a pressure of the gas from the first source is greater than or equal to atmospheric pressure.

H. The fuel evacuation system of any one of the preceding paragraphs, wherein the pressure of the gas from the first source is less than atmospheric pressure.

I. The fuel evacuation system of any one of the preceding paragraphs, wherein the sealing member comprises:
a collar portion; and
a plug concentrically arranged within the collar portion;
wherein the collar portion is configured to couple to an exterior of the outer fluid pathway, and wherein the plug is configured to be received within a portion of each of the outer fluid pathway and the inner fluid pathway.

J. The fuel evacuation system of paragraph I, wherein the plug is spaced from a terminal end of each of the outer fluid pathway and the inner fluid pathway when the sealing member is in the second position; and
the plug is received by the terminal end of each of the outer fluid pathway and the inner fluid pathway when the sealing member is in the first position.

K. A fuel supply component comprising:
a sealing member configured to threadably couple to a terminal end of a conduit;
a collar configured to couple to the conduit; and
a plug extending through the collar, the plug comprising a first portion extending from a first side of the collar and a second portion extending into a hollow portion of the collar;
wherein an inner portion of the collar is threaded.

L. The fuel supply component of paragraph K, wherein the conduit comprises:
an inner wall and an outer wall, wherein an inner fluid pathway is defined by the inner wall, and an outer fluid pathway is defined by a space between the inner wall and the outer wall, the outer wall surrounding the inner wall; wherein the first fluid pathway is in fluid communication with a first source and the second fluid pathway is in fluid communication with a second source;
wherein the sealing member is moveable between a first position and at least one second position; and
wherein a first stream from the first source flows from the first fluid pathway to the second fluid pathway or a second stream from the second source flows from the second fluid pathway to the first fluid pathway when the sealing member is in the at least one second position, and
the first fluid pathway is fluidly isolated from the second fluid pathway when the sealing member is in the first position.

M. The fuel supply component of paragraph K or L, wherein a diameter of the second portion of the plug is stepped.

N. The fuel supply component of any one of paragraphs K to M, wherein the collar is configured to couple to the outer wall; and
the valve portion is configured to seal each of the inner fluid pathway and the outer fluid pathway when the sealing member is in the first position, and configured to unseal each of the inner fluid pathway and the outer fluid pathway when the sealing member is in the at least one second position.

O. The fuel supply component of paragraph N, wherein the second portion is structured as a valve.

P. The fuel supply component of paragraph L, further comprising a second conduit fluidly coupled to the outer fluid pathway at a first end and a second end, the outer conduit configured to receive a third stream from a third source.

Q. The fuel supply component of paragraph P, wherein the first stream is a liquid fuel and the third stream is a first gas.

R. The fuel supply component of any one of paragraphs K to P, wherein the first stream is a liquid and the second stream is a second gas.

S. A method of evacuating a fuel within an engine by a fuel evacuation system, the fuel evacuation system having an outer fluid pathway in fluid communication with a gas from a first source, an inner fluid pathway arranged within the outer fluid pathway and being in fluid communication with a liquid fuel from a second source, and a sealing member coupled to a terminal end of each of the outer fluid pathway and the inner fluid pathway, wherein the method comprises:
repositioning the sealing member within the fuel evacuation system from a first position to at least one second position such that the outer fluid pathway is in fluid communication with the inner fluid pathway; and
while the sealing member is in the at least one second position, controlling, by a controller operably coupled to the fuel evacuation system, the fuel evacuation system in one of a first purging mode or a second purging mode.

T. The method of paragraph S, wherein controlling the fuel evacuation system in the first purging mode comprises:
causing gas from the first source to flow from the outer fluid pathway to the inner fluid pathway to purge liquid fuel within the inner fluid pathway such that the liquid fuel within the inner fluid pathway flows to the second source.

U. The method of paragraph S or T, wherein controlling the fuel evacuation system in the second purging mode comprises: causing liquid fuel from the second source to flow from the inner fluid pathway to the outer fluid pathway to purge gas within the outer fluid pathway such that gas within the outer fluid pathway flows to the first source.

V. The method of any one of paragraphs S to U, wherein repositioning the sealing member from the first position to the at least one second position comprises unthreading the sealing member from the terminal end of each of the outer fluid pathway and the inner fluid pathway.

W. The method of any one of paragraphs S to V, further comprising controlling, by the controller, a pressure of the gas from the first source.

X. The method of any one of paragraphs S to W, wherein repositioning the sealing member from the first position to the at least one second position comprises:
spacing the sealing member from a terminal end from each of the outer fluid pathway and the inner fluid pathway.

Y. The method of paragraph X, wherein spacing the sealing member from the terminal end of each of the outer fluid pathway and the inner fluid pathway comprises:
moving a collar portion of the sealing member away from an outer wall of the outer fluid pathway such that a plug within the collar portion unseals the terminal end of each of the outer fluid pathway and the inner fluid pathway.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above.

It is important to note that any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A fuel evacuation system for an engine, the system comprising:
an outer fluid pathway in fluid communication with a gas from a first source;
an inner fluid pathway arranged within the outer fluid pathway, the inner fluid pathway in fluid communication with a liquid fuel from a second source;
at least one controller configured to control flow of the gas from the first source and flow of the liquid fuel from the second source; and
a sealing member coupled to a terminal end of each of the outer fluid pathway and the inner fluid pathway;
wherein the sealing member is selectively operable between a first position and at least one second position;
wherein, in the first position, the sealing member enables the outer fluid pathway to be fluidly independent from the inner fluid pathway; and
wherein, in the second position, the sealing member enables the outer fluid pathway to be fluidly coupled to the inner fluid pathway such that the fuel evacuation system can be operable in one of a first mode or a second mode;
wherein in the first mode, the at least one controller is configured to cause liquid fuel from the second source to flow from the inner fluid pathway to the outer fluid pathway such that gas within the outer fluid pathway flows toward the first source; and
wherein in the second mode, the at least one controller is configured to cause gas from the first source to flow from the outer fluid pathway to the inner fluid pathway such that liquid fuel within the inner fluid pathway flows toward the second source.

2. The fuel evacuation system of claim 1, further comprising a fuel line fluidly coupled to each of the first source and the second source, the fuel line comprising a first wall and a second wall, the second fluid pathway being formed by a space defined within the second wall and the first fluid pathway being formed by a space defined between the second wall and the first wall.

3. The fuel evacuation system of claim 2, wherein the fuel line is a fuel line configured to provide the liquid fuel to a plurality of cylinders within the engine.

4. (canceled)

5. (canceled)

6. The fuel evacuation system of claim 1, wherein the inner fluid pathway is concentrically arranged within the outer fluid pathway.

7. (canceled)

8. (canceled)

9. The fuel evacuation system of claim 1, wherein the sealing member comprises:
a collar portion; and
a plug concentrically arranged within the collar portion;
wherein the collar portion is configured to couple to an exterior of the outer fluid pathway, and wherein the plug is configured to be received within a portion of each of the outer fluid pathway and the inner fluid pathway.

10. The fuel evacuation system of claim 9, wherein the plug is spaced from a terminal end of each of the outer fluid pathway and the inner fluid pathway when the sealing member is in the second position; and
the plug is received by the terminal end of each of the outer fluid pathway and the inner fluid pathway when the sealing member is in the first position.

11. A fuel supply component comprising:
a sealing member configured to threadably couple to a terminal end of a conduit;
a collar configured to couple to the conduit; and
a plug extending through the collar, the plug comprising a first portion extending from a first side of the collar and a second portion extending into a hollow portion of the collar;
wherein an inner portion of the collar is threaded.

12. The fuel supply component of claim 11, wherein the conduit comprises:
an inner wall and an outer wall, wherein an inner fluid pathway is defined by the inner wall, and an outer fluid pathway is defined by a space between the inner wall and the outer wall, the outer wall surrounding the inner wall;
wherein the first fluid pathway is in fluid communication with a first source and the second fluid pathway is in fluid communication with a second source;
wherein the sealing member is moveable between a first position and at least one second position; and
wherein a first stream from the first source flows from the first fluid pathway to the second fluid pathway or a second stream from the second source flows from the second fluid pathway to the first fluid pathway when the sealing member is in the at least one second position, and
the first fluid pathway is fluidly isolated from the second fluid pathway when the sealing member is in the first position.

13. The fuel supply component of claim 11, wherein a diameter of the second portion of the plug is stepped.

14. The fuel supply component of claim 12, wherein the collar is configured to couple to the outer wall; and
the valve portion is configured to seal each of the inner fluid pathway and the outer fluid pathway when the sealing member is in the first position, and configured to unseal each of the inner fluid pathway and the outer fluid pathway when the sealing member is in the at least one second position.

15. The fuel supply component of claim 14, wherein the second portion is structured as a valve.

16. The fuel supply component of claim 12, further comprising a second conduit fluidly coupled to the outer fluid pathway at a first end and a second end, the outer conduit configured to receive a third stream from a third source.

17. The fuel supply component of claim 16, wherein the first stream is a liquid fuel and the third stream is a first gas.

18. The fuel supply component of claim 16, wherein the first stream is a liquid and the second stream is a second gas.

19. A method of evacuating a fuel within an engine by a fuel evacuation system, the fuel evacuation system having an outer fluid pathway in fluid communication with a gas from a first source, an inner fluid pathway arranged within the outer fluid pathway and being in fluid communication with a liquid fuel from a second source, and a sealing member coupled to a terminal end of each of the outer fluid pathway and the inner fluid pathway, wherein the method comprises:
repositioning the sealing member within the fuel evacuation system from a first position to at least one second position such that the outer fluid pathway is in fluid communication with the inner fluid pathway; and
while the sealing member is in the at least one second position, controlling, by a controller operably coupled to the fuel evacuation system, the fuel evacuation system in one of a first purging mode or a second purging mode.

20. The method of claim 19, wherein controlling the fuel evacuation system in the first purging mode comprises:
causing gas from the first source to flow from the outer fluid pathway to the inner fluid pathway to purge liquid fuel within the inner fluid pathway such that the liquid fuel within the inner fluid pathway flows to the second source.

21. The method of claim 19, wherein controlling the fuel evacuation system in the second purging mode comprises:
causing liquid fuel from the second source to flow from the inner fluid pathway to the outer fluid pathway to purge gas within the outer fluid pathway such that gas within the outer fluid pathway flows to the first source.

22. The method of claim 19, wherein repositioning the sealing member from the first position to the at least one second position comprises unthreading the sealing member from the terminal end of each of the outer fluid pathway and the inner fluid pathway.

23. The method of claim 19, further comprising controlling, by the controller, a pressure of the gas from the first source.

24. The method of claim 19, wherein repositioning the sealing member from the first position to the at least one second position comprises:
spacing the sealing member from a terminal end from each of the outer fluid pathway and the inner fluid pathway;
wherein spacing the sealing member from the terminal end of each of the outer fluid pathway and the inner fluid pathway comprises:
moving a collar portion of the sealing member away from an outer wall of the outer fluid pathway such that a plug within the collar portion unseals the terminal end of each of the outer fluid pathway and the inner fluid pathway.

25. (canceled)
